(19) United States
(12) Patent Application Publication
(10) Pub. No.: US 2006/0293411 A1
(43) Pub. Date: Dec. 28, 2006

(54) Ink set, ink jet recording method and droplet ejecting apparatus

(75) Inventors: Hiroyuki Ueki, Kanagawa (JP); Kunichi Yamashita, Kanagawa (JP)

Correspondence Address: FILDES & OUTLAND, P.C., 20916 MACK AVENUE, SUITE 2, GROSSE POINTE WOODS, MI, 48236, US

(73) Assignee: Fuji Xerox Co. Ltd.

(21) Appl. No.: 11/351,969

(22) Filed: Feb. 10, 2006

(30) Foreign Application Priority Data
Jun. 23, 2005 (JP) 2005-183789

(51) Int. Cl. C03C 17/00

(52) U.S. Cl. 523/160

(57) ABSTRACT

The invention provides an ink set having at least: an ink comprising a pigment and a resin that disperses the pigment; and a liquid that coagulates the pigment. The neutralization degree of the resin is in a range of about 0.1 to 0.6. The acid value of the resin is in a range of about 100 to 400 KOH mg/g. The amount of the resin contained in the ink is in a range of about 20 to 100% by mass relative to the amount of the pigment contained in the ink. The invention further provides an ink jet recording method including forming an image by imparting the ink set onto a surface of a recording medium. The invention further provides a droplet ejecting apparatus having a droplet ejecting unit that forms an image by ejecting droplets of the ink set onto a surface of a recording medium.

### CROSS-REFERENCE TO RELATED APPLICATION

This application claims priority under 35 USC 119 from Japanese Patent Application No. 2005-183789, the disclosure of which is incorporated by reference herein.

### BACKGROUND OF THE INVENTION

1. Field of Invention

The invention relates to an ink set for use in recording an image on a recording medium such as paper by using ink. The invention further relates to an ink jet recording method and a droplet ejecting apparatus using the same.

2. Description of the Related Art

So-called ink jet recording apparatuses, which perform recording processes by ejecting liquid or molten solid ink through a nozzle, slit, porous film or the like onto a medium such as paper, cloth, films, or the like, have various advantages including smaller size, low cost, and low noise. Recently, in addition to single-color black printers, there are many commercially available products that can perform full-color printing and give images favorable in printing quality on so-called plain paper such as report paper or copier paper.

While both dyes and pigments may be used as colorants for ink used in ink jet recording, use of a pigment is preferable in view of obtaining an image having superior water resistance and resistance to climatic conditions, high image density and little ink bleeding. However, it is difficult disperse pigments in ink because pigments are inherently hydrophobic. Accounting for this problem, a dispersant (resin) is often used in pigment-containing ink in order to facilitate dispersion of the pigment.

On the other hand, pigment-containing inks have problems such as clogging in the vicinity of the nozzles of recording heads due to vaporization of water and associated deterioration in ejection stability. In order to solve the problems, a method including using a resin having the acid value of 120 to 400 mg-KOH/g, the neutralization degree of less than 1, and a value of “acid value×neutralization degree” of 110 or more as the dispersant has been proposed (Japanese Patent Application Laid-Open No. 2004-300166).

Also known is a method including using a liquid that-aggregates colorant components in an ink (hereinafter, the liquid is referred to as “processing liquid”) in combination with the ink so as to improve image density. This method, which forms an image on a recording medium such as paper by ejecting an ink and a processing liquid thereon in such a manner that they contact with each other and mix, provides an image having higher image density because the colorants in the ink are rapidly aggregated and fixed on the surface of the recording medium when the ink and the processing liquid are mixed.

However, when an image is formed using a processing liquid and an ink containing a dispersant and pigments, a great amount of liquid components are applied on a recording medium, causing a problem that the image tends to be blurred because of decrease in drying property (fast drying ability). In addition, it is necessary to add a greater amount of pigments to an ink in order to improve the image density further, and in such a case, the dispersant (resin) should also be added in a greater amount. This increase in the amount of resins consequently leads to deterioration in the ejectability of the ink from the recording head.

### SUMMARY OF THE INVENTION

Considering the problems above, the inventors have studied drying property, image density, and ejection stability when printing is conducted using a processing liquid in combination with an ink, from the viewpoints of the physical properties and the components of the ink and the processing liquid.

As a result, it was found that the dispersion stability of the pigments is good and the drying property is favorable when a resin having a high acid value and a low neutralization degree (for example, acid value: approximately 400 mg-KOH/g, neutralization degree: approximately 0.15) is used as the resin while a ratio of the resin to the pigments (dispersant content) was kept constant, and that the drying property and the image density are deteriorated when a resin having a low acid value and a high neutralization degree (for example, acid value: approximately 100 mg-KOH/g, neutralization degree: approximately 0.7) is used. It was also found that a greater ratio of the resin to the pigments in an ink leads to an improvement in drying property and image density as well as to deterioration in ejectability when the resin acid value and the neutralization degree are kept constant. Based on these observations, the inventors considered that the acid value and the neutralization degree of the resin used for dispersion of pigments (i.e., number of neutralized acid groups in the resin) and the ratio of the resin to the pigments are related to improvement and balance of the three properties, namely, drying property, image density and ejection stability, of the resulting ink in a printing method that uses a processing liquid in addition to an ink and (hereinafter, such printing method is referred to as “two-liquid printing”), and completed the following invention.

Namely, the invention provides an ink set comprising: an ink comprising a pigment and a resin that disperses the pigment; and a liquid that coagulates the pigment, wherein: the neutralization degree of the resin is in a range of about 0.1 to 0.6; the acid value of the resin is in a range of about 100 to 400 KOH mg/g; and the amount of the resin contained in the ink is in a range of about 20 to 100% by mass relative to the amount of the pigment contained in the ink.

The invention further provides an ink jet recording method comprising forming an image by imparting the ink set onto a surface of a recording medium.

The invention further provides a droplet ejecting apparatus comprising a droplet ejecting unit that forms an image by ejecting droplets of the ink set onto a surface of a recording medium.

### BRIEF DESCRIPTION OF THE DRAWINGS

FIG. 1 A perspective view showing an appearance of a constitution of an ink jet recording device according to a preferable embodiment of the invention.

FIG. 2 A perspective view showing a basic internal structure of the ink jet recording device of FIG. 1.

FIG. 3 A perspective view showing an appearance of a constitution of an ink jet recording device according to another preferable embodiment of the invention.

FIG. 4 A perspective view showing a basic internal structure of the ink jet recording device of FIG. 3.

### DETAILED DESCRIPTION OF THE INVENTION

Ink Set

The ink set of the present invention is an ink set comprising: an ink comprising a pigment and a resin that disperses the pigment; and a liquid that coagulates the pigment, wherein: the neutralization degree of the resin is in a range of about 0.1 to 0.6; the acid value of the resin is in a range of about 100 to 400 KOH mg/g; and the amount of the resin contained in the ink is in a range of about 20 to 100% by mass relative to the amount of the pigment contained in the ink.

It is possible to obtain superior drying property, image density and ejectability, by forming an image by using the ink set according to the invention by using a droplet ejecting apparatus such as an ink jet recording apparatus.

When the resin has the neutralization degree of less than approximately 0. 1, it may lead to deterioration in ejectability, while when neutralization degree is more than approximately 0.6, it may lead to deterioration in drying property. When the resin has the acid value of less than approximately 100 mg-KOH/g, it may lead to deterioration in ejectability, while when the acid value is more than approximately 400 mg-KOH/g it may lead to deterioration in image density.

In addition, when the resin is contained in the ink in the amount of less than approximately 20 wt % with respect to pigments, it may not be possible to obtain sufficiently high image density, while when the amount is more than approximately 100 wt %, it may lead to deterioration in ejection stability.

In view of making the drying property, image density and ejectability well-balanced at higher levels, the combination of the resin neutralization degree, the resin acid value and the ratio of the resin to the pigments is preferably that in which the neutralization degree is in a range of approximately 0.1 to 0.5, the acid value is in a range of approximately 100 to 400 mg-KOH/g, and the amount of the resin in ink is in a range of approximately 20 to 100 wt % with respect to the amount of the pigments. Further, in view of making the three properties balanced at further high levels, the combination is more preferably that in which the neutralization degree is in a range of approximately 0.15 to 0.5, the acid value is in a range of approximately 100 to 300 mg-KOH/g, and the amount of the resin in ink is in a range of approximately 25 to 80 wt % with respect to the amount of the pigments.

Among resins having the neutralization degree and the acid value in the ranges above, use of a resin having a relatively low acid value and a low-neutralization degree (acid value: approximately 100 to 200 mg-KOH/g, and neutralization degree: approximately 0.1 to 0.5) is advantageous in that it is possible to stably eject the ink without coggation even when printing is performed in an ink jet recording apparatus equipped with a recording head in the so-called thermal process.

In the invention, the acid value can be determined by dissolving a resin in an organic solvent such as THF or toluene and neutralization-titrating the solution using a neutralizer (KOH), and the neutralization degree defined by “neutralizer amount (g)/resin amount (g)/neutralizer molecular weight/(acid value/56100)” from the quantitative determination result using KOH.

Preferably in the ink for use in the invention, the resin used as a dispersant coats the surface of pigments, and there resides fewer amount of free resin which is not bound to the pigments. It is because, if the free resin is present in a greater amount, not only the resin which coat the pigment surface but also the free resin react with the processing liquid when the ink and the processing liquid are mixed on a recording medium and possibly result in deterioration in the aggregation efficiency of the pigments and thus result in deterioration image density.

For this reason, the amount of a residue in a supernatant liquid obtained after centrifugation of the ink is preferably approximately 4 wt % or less and more preferably approximately 2 wt % or less relative to a total amount of the supernatant liquid, and the amount of the residue is preferably as small as possible.

When the ink is prepared by using an aqueous dispersion of pigment (hereinafter referred to as a “pigment dispersion”) in which the pigment is previously dispersed with the resin, the amount of the residue in the supernatant obtained after centrifugation of the pigment dispersion in a similar manner to above is preferably approximately 4 wt % or less, because a composition and ratios of the components of the solid matters in the pigment dispersion are not significantly different from those of the ink.

Specifically, the amount of the residue in the supernatant liquid is determined as follows. First, the concentration of the pigment in ink is adjusted to approximately 10 wt %, and approximately 200 ml of the pigment concentration-adjusted ink is centrifuged at approximately 23,000×g (g: gravitational acceleration) for approximately 8 hours. The amount of the residue in supernatant liquid is then determined by collecting approximately 5 g of the supernatant liquid of the ink after centrifugation, completely removing the solvents such as water in the supernatant liquid by vaporization, and measuring the weight of the residue.

The residue obtained from the supernatant liquid, from which pigment components are removed by centrifugation, is thought to contain the free resin as well as the alkali metal used for neutralization of the resin, unpurified pigments, and the like. It is thought that absolute amounts of the alkali metal, unpurified pigments and the like in the ink (or in the pigment dispersion) are not so large and do not significantly vary regardless of the kind of the ink used. Thus, a component which influence on variation of the absolute amount of the residue in supernatant liquid is thought to be the resin which is highly compatible with the solvent components in the ink such as water. For that reason, the amount of the residue in the supernatant liquid may be regarded as reflecting the amount of the free resin.

Ink

Hereinafter, the ink for use in the invention will be described in more detail.

The ink for the ink set according to the invention may be a single ink. However, use of inks for four colors including a black ink (for example, a combination of a black color ink, a cyan color ink, a magenta color ink, and a yellow color ink) is preferable for production of a color image.

In addition, the ink for use in the invention is not particularly limited as long as it contains at least a pigment, a resin (dispersant) used for dispersing the pigment, and a solvent such as water, and the ink may further contain other components such as a neutralizer for neutralizing the resin in accordance with necessity.

Pigment

Any conventionally-known pigments may be used as the pigment. Specific examples of black pigments include, but are not limited to, RAVEN 7000, RAVEN 5750, RAVEN 5250, RAVEN 5000 ULTRA II, RAVEN 3500, RAVEN 2000, RAVEN 1500, RAVEN 1250, RAVEN 1200, RAVEN 1190 ULTRA II, RAVEN 1170, RAVEN 1255, RAVEN 1080, and RAVEN 1060 (all trade name, manufactured by COLUMBIAN CARBON COMPANY); REGAL& 400R, REGAL® 330R, REGAL® 660R, MOGUL® L, BLACK PEARLS L, MONARCH® 700, MONARCH® 800, MONARCH® 880, MONARCH® 900, MONARCH® 1000, MONARCH® 1100, MONARCH® 1300, and MONARCH® 1400 (all trade name, manufactured by Cabot Corporation); COLOR BLACK® FW1, COLOR BLACK® FW2, COLOR BLACK® FW2 V, COLOR BLACK® 18, COLOR BLACK® FW200, COLOR BLACK® S 150, COLOR BLACK® S 160, COLOR BLACKS S 170, PRINTEX® 35, PRINTEX® U, PRINTEX® V, PRINTEX® 140U, PRINTEX® 140 V, SPECIAL BLACK® 6, SPECIAL BLACKS 5, SPECIAL BLACKS 4A, and SPECIAL BLACK® 4 (all trade name, manufactured by Degussa AG); and No.25, No.33, No.40, No.47, No.52, No.900, No.2300, MCF-88, MA600, MA7, MA8, and MA100 (all trade name, manufactured by Mitsubishi Chemical Corporation).

Specific examples of cyan ink pigments include, but are not limited to, C.I. Pigment Blue-1, 2, 3, 15, 15:1, 15:2, 15:3, 15:4, 16, 22, 60, and the like.

Specific examples of magenta ink pigments include, but are not limited to, C.I. Pigment Red-5, 7, 12, 48, 48:1, 57, 112, 122, 123, 146, 168, 184, 202, and the like.

Specific examples of yellow ink pigments include, but are not limited to, C.I. Pigment Yellow-1, 2, 3, 12, 13, 14, 16, 17, 73, 74, 75, 83, 93, 95, 97, 98, 114, 128, 129, 138, 151, and 154, and the like.

The amount of the pigment contained in the ink is preferably in a range of approximately 3 to 15 wt % relative to the total amount of the ink, and preferably in a range of approximately 3 to 8 wt % relative to the total amount of the ink. When the amount of the pigment is less than approximately 3% by weight, it may lead to insufficient image density. On the other hand, when the amount of the pigment is more than approximately 15% by weight, it may lead to inadequate dispersion of pigment and deterioration in the storage stability of ink.

Dispersant for Pigments

Resins that satisfy the above-described acid value and neutralization degree (hereinafter, sometimes referred to as a “polymer dispersant”) are used for dispersing the pigment, and the various surfactants described below may be additionally used in accordance with necessity.

A polymer having both hydrophilic and hydrophobic structural regions is used effectively as the polymer dispersant. Examples of the polymers having hydrophilic and hydrophobic structural regions include condensation polymers and addition polymers. Specific examples of the condensation polymers include known polyester dispersants. Specific examples of the addition polymers include polymers produced from a,p-ethylenically unsaturated group-containing monomer, and the like. It is possible to obtain a desirable polymer dispersant, by copolymerizing α,β-ethylenically unsaturated group-containing monomer having a hydrophilic group and α,β-ethylenically unsaturated group-containing monomer having a hydrophobic group properly in combination. In addition, homopolymers of a monomer having α,β-ethylenically unsaturated group that has a hydrophilic group may also be used.

Examples of the α,β-ethylenically unsaturated group-containing monomers having a hydrophilic group include monomers having a carboxyl, sulfonic acid, hydroxyl, phosphoric acid group, or the like, such as acrylic acid, methacrylic acid, crotonic acid, itaconic acid, itaconic acid monoester, maleic acid, maleic acid monoester, fumaric acid, fumaric acid monoester, vinylsulfonic acid, styrenesulfonic acid, sulfonated vinylnaphthalene, vinyl acetate (raw material for polyvinylalcohol), acrylamide, methacryloxyethyl phosphate, bis methacryloxyethyl phosphate, methacryloxyethylphenyl acid phosphate, ethylene glycol dimethacrylate, diethylene glycol dimethacrylate, and the like.

Further, examples of the a,o-ethylenically unsaturated group-containing monomers having a hydrophobic group include styrene compounds such as styrene, a-methylstyrene, and vinyltoluene, vinylcyclohexane, vinylnaphthalene, vinylnaphthalene compounds, alkyl acrylate esters, phenyl acrylate ester, alkyl methacrylate esters, phenyl methacrylate ester, cycloalkyl methacrylate esters, alkyl crotonate esters, dialkyl itaconate esters, dialkyl maleate esters, and the like.

Preferable examples of the copolymers prepared from these monomers and others include styrene-styrenesulfonic acid copolymers, styrene-maleic acid copolymers, styrene-methacrylic acid copolymers, styrene-acrylic acid copolymers, vinylnaphthalene-maleic acid copolymers, vinylnaphthalene-methacrylic acid copolymers, vinylnaphthalene-acrylic acid copolymers, alkyl acrylate ester-acrylic acid copolymers, alkyl methacrylate ester-methacrylic acid copolymers, styrene-alkyl methacrylate ester-methacrylic acid copolymers, styrene-alkyl acrylate ester-acrylic acid copolymers, styrene-phenyl methacrylate ester-methacrylic acid copolymers, styrene-cyclohexyl methacrylate ester-methacrylic acid copolymers, styrene-methacrylic acid copolymers, and the like.

In addition, these copolymers may contain additionally a monomer having a polyoxyethylene or hydroxyl group as needed as a copolymerization component.

The copolymers may have any copolymer structures such as random coplymer, block copolymer, graft copolymer, or the like. In addition, polystyrenesulfonic acid, polyacrylic acid, polymethacrylic acid, polyvinylsulfonic acid, polyalginic acid, polyoxyethylene-polyoxypropylene-polyoxyethylene block copolymers, naphthalenesulfonic acid/formalin condensates, polyvinylpyrrolidone, polyethyleneimine, polyamines, polyamides, polyvinylimidazoline, aminoalkyl acrylate D-acrylamide copolymers, chitosan, polyoxyethylene fatty acid amides, polyvinylalcohol, polyacrylamide, cellulose compounds such as carboxymethylcellulose and carboxyethylcellulose, polysaccharides and compounds thereof, and the like may also be used. At least one of the hydrophilic groups contained in the dispersant is preferably a carboxyl group.

In addition, the molecular weight (weight-average molecular weight expressed by a styrene as determined by GPC (gel permeation chromatography)) of the polymer dispersant is preferably in a range of approximately 8,000 to 100,000, and preferably in a range of approximately 10,000 to 50,000. A molecular weight of less than approximately 8,000 may lead to deterioration in the dispersion stability of pigment, while a molecular weight of more than approximately 100,000 to increase in the viscosity of the ink and deterioration in ejectability.

In measurement of the molecular weight, HLC-8120GPC, SC-8020 (trade name, manufactured by Tosoh Corporation) is used in the GPC analysis, two columns of TSK gel (trade name: Super HM-H, manufactured by Tosoh Corporation, 6.0 mmID×15 cm) are used as columns; and THF (tetrahydrofuran) are used as an eluant. As for the measuring conditions, the sample concentration is 0.5%: the flow rate is 0.6 ml/min, the sample injection amount is 10 μl; the measurement temperature is 40° C.; and the detector is an IR detector. A calibration curve is prepared by using ten polystyrene standard samples, namely “A-500”, “F-1”, “F-10”, “F-80”, “F-380”, “A-2500”, “F-4”, “F-40”, “F-128”, and “F-700” of TSK STANDARDS (all trade names, manufactured by Tosoh Corp.).

In addition, alkali metals such as Na, Li, or the like, organic amines such as triethanolamine, diethanolamine, or the like may be used as neutralizing agents during neutralization of the polymer dispersant, and two or more neutralizing agents may be used in combination. The species and the addition amount of the neutralizing agent may be appropriately selected so as to obtain desired acid values and neutralization degrees.

Other Additives

In addition to the above-described components, the ink further contains water as a solvent, and may further contain a water-soluble organic solvent. Addition of the water-soluble organic solvent to ink is effective in improving the water-retention efficiency of ink and processing liquid, and the dispersability of the pigment in ink, preventing clogging and preserving the ejection stability when ink is ejected from a recording head, and avoiding aggregation/precipitation of the pigment and the surface-finishing agent contained in the processing liquid during long-term preservation of inks.

Specific examples of the water-soluble organic solvents include polyvalent alcohols such as ethylene glycol, diethylene glycol, propylene glycol, butylene glycol, triethylene glycol, 1,5-pentanediol, 1,2,6-hexanetriol, glycerol and the like.

Examples of the glycol ethers include polyvalent alcohol compounds such as ethylene glycol monomethylether, ethylene glycol monoethylether, ethylene glycol monobutylether, diethylene glycol monomethylether, diethylene glycol monoethylether, diethylene glycol monobutylether, propylene glycol monobutyl ether, dipropylene glycol monobutylether, ethylene oxide adducts of di glycerin, and the like.

Examples of the nitrogen-containing solvents include pyrrolidone, N-methyl-2-pyrrolidone, cyclohexylpyrrolidone, triethanolamine, and the like.

Examples of the sulfur-containing solvents include thiodiethanol, thiodiglycerol, sulfolane, dimethylsulfoxide, and the like. In addition, propylene carbonate, ethylene carbonate, or the like may be used in combination. An alcohol such as ethanol, isopropyl alcohol, butyl alcohol, or benzyl alcohol may also be used. The amount of the water-soluble organic solvent used is approximately 1 to 60% by weight relative to a total amount of the ink, and preferably approximately 5 to 40% by weight relative to a total amount of the ink.

In addition, the ink may contain a surfactant. A compound having a structure of both hydrophilic and hydrophobic regions in the molecule may be used as the surfactant, and anionic surfactants, cationic surfactants, amphoteric surfactants, nonionic surfactants, or the like may be used.

Preferable examples of the anionic surfactants include alkylbenzenesulfonate salts, alkylphenylsulfonate salts, alkylnaphthalenesulfonate salts, higher fatty acid salts, sulfuric ester salts of a higher fatty acid ester, sulfonate salts of a higher fatty acid ester, sulfate ester and sulfonate salts of an higher alcohol ether, higher-alkyl sulfoscuccinate salts, higher-alkylphosphoric ester salts, phosphoric ester salts of a higher alcohol ethylene oxide adduct, and the like; and, for example, dodecylbenzenesulfonate salts, kellyl benzene sulfonate salts, isopropylnaphthalenesulfonate salts, monobutylphenylphenol monosulfonate salts, monobutylbiphenyl sulfonate salts, dibutylbiphenyl sulfonate salts, dibutylphenylphenol disulfonate salts, and the like.

Examples of the nonionic surfactants include polypropylene glycol ethylene oxide adducts, polyoxyethylene nonylphenylether, polyoxyethylene octylphenylether, polyoxyethylene dodecylphenylether, polyoxyethylene alkylethers, polyoxyethylene fatty acid esters, sorbitan fatty acid esters, polyoxyethylene sorbitan fatty acid esters, fatty acid alkylol amides, acetylene glycol, oxyethylene adducts of an acetylene glycol, aliphatic alkanol amides, glycerol esters, sorbitan esters, and the like.

Examples of the cationic surfactants include tetraalkylammonium salts, alkylamine salts, benzalkonium salts, alkylpyridinium salts, imidazolium salts, and the like; for example, dihydroxyethylstearylamine, 2-heptadecenyl-hydroxyethylimidazoline, lauryldimethylbenzylammonium chloride, cetylpyridinium chloride, stearamidomethylpyridium chloride, and the like.

In addition, silicone surfactants such as polysiloxane oxyethylene adducts, fluorine surfactants such as perfluoroalkyl carboxylate salts, perfluoroalkyl sulfonate salts, oxyethylene perfluoroalkylethers, or the like, bio-surfactant such as spiculisporic acid, rhamnolipids, lysolecithins, or the like may be used.

The addition amount of the surfactant to the ink is preferably less than approximately 10% by weight relative to a total amount of the ink. When the addition amount of is approximately 10% by weight or more, it may lead to deterioration in image density and storage stability of the ink.

In addition, polyethyleneimine, polyamines, polyvinylpyrrolidone, polyethylene glycol, cellulose compounds such as ethylcellulose, carboxymethylcellulose, or the like, polysaccharides or compounds thereof, other water-soluble polymers, polymer emulsions such as acrylic polymer emulsion, polyurethane-based emulsion, or the like, cyclodextrin, macrocyclic amines, dendrimers, crown ethers, urea or compounds thereof, acetamide, or the like may be used for the purpose of controlling of properties such as an improvement in the ejectability of inks.

In addition, an alkali metal compound such as potassium hydroxide, sodium hydroxide, or lithium hydroxide, a nitrogen-containing compound such as ammonium hydroxide, triethanolamine, diethanolamine, ethanolamine, or 2-amino-2-methyl-I-propanol, or the like may be used for control of conductivity and pH.

Further, other additives such as antioxidant, fungicide, viscosity adjuster, conductive substance, ultraviolet absorbent, or the like may be added as needed.

Processing Liquid

A mixture which contains essentially no colorant component such as pigment, but contains at least a component (coagulant) aggregating the pigment in ink and a solvent such as water is used as a processing liquid, and the mixture may contain other components as needed.

An inorganic electrolyte, an organic amine compound, an organic acid, or the like is used as a coagulant.

A pH adjuster, a polyvalent metal salt, or the like is used as an inorganic electrolyte. Specific examples of the pH adjuster include 2-pyrrolidone-5-carboxylic acid, 4-methyl-4-pentanolido-3-carboxylic acid, furancarboxylic acid, 2-benzofurancarboxylic acid, 5-methyl-2-furancarboxylic acid, 2,5-dimethyl-3-furancarboxylic acid, 2,5-furandicarboxylic acid, 4-butanolido-3-carboxylic acid, 3-hydroxy-4-pyrone-2,6-dicarboxylic acid, 2-pyrone-6-carboxylic acid, 4-pyrone-2-carboxylic acid, 5-hydroxy-4-pyrone-5-carboxylic acid, 4-pyrone-2,6-dicarboxylic acid, 3-hydroxy-4-pyrone-2,6-dicarboxylic acid, thiophenecarboxylic acid, 2-pyrrolecarboxylic acid, 2,3-dimethylpyrrole-4-carboxylic acid, 2,4,5-trimethylpyrrole-3-propionic acid, 3-hydroxy-2-indolecarboxylic acid, 2,5-dioxo-4-methyl-3-pyrroline-3-propionic acid, 2-pyrrolidinecarboxylic acid, 4-hydroxyproline, 1-methylpyrrolidine-2-carboxylic acid, 5-carboxy-1-methylpyrrolidine-2-acetic acid, 2-pyridinecarboxylic acid, 3-pyridinecarboxylic acid, 4-pyridinecarboxylic acid, pyridinedicarboxylic acid, pyridinetricarboxylic acid, pyridinepentacarboxylic acid, 1,2,5,6-tetrahydro-1-methylnicotinic acid, 2-quinolinecarboxylic acid, 4-quinolinecarboxylic acid, 2-phenyl-4-quinolinecarboxylic acid, 4-hydroxy-2-quinolinecarboxylic acid, 6-methoxy-4-quinolinecarboxylic acid, potassium hydrogen phthalate, potassium dihydrogen phosphate, boric acid, sodium citrate, potassium citrate, sodium tetraborate, tartaric acid, lactic acid, ammonium chloride, sodium hydroxide, potassium hydroxide, hydrochloric acid, compounds and salts of these compounds, and the like.

Among these, pyrrolidonecarboxylic acid, pyronecarboxylic acid, pyrrolecarboxylic acid, furancarboxylic acid, pyridinecarboxylic acid, coumarinic acid, thiophenecarboxylic acid, nicotinic acid, potassium dihydrogen citrate, succinic acid, tartaric acid, lactic acid, potassium hydrogen phthalate, and compounds or salts of these compounds are preferable. More preferable are pyrrolidonecarboxylic acid, pyronecarboxylic acid, furancarboxylic acid, coumarinic acid, and compounds or salts of these compounds.

Further, examples of the inorganic electrolytes include alkali metal ions such as lithium ion, sodium ion, and potassium ion; polyvalent metal ions such as aluminum ion, barium ion, calcium ion, copper ion, iron ion, magnesium ion, manganese ion, nickel ion, tin ion, titanium ion, and zinc ion; salts of hydrochloric acid, hydrobromic acid, hydroiodic acid, sulfuric acid, nitric acid, phosphoric acid, thiocyanic acid, organic carboxylic acids such as acetic acid, oxalic acid, lactic acid, fumaric acid, citric acid, salicylic acid, benzoic acid, and the like or organic sulfonic acids; and the like.

Specific examples thereof include alkali metal salts such as lithium chloride, sodium chloride, potassium chloride, sodium bromide, potassium bromide, sodium iodide, potassium iodide, sodium sulfate, potassium nitrate, sodium acetate, potassium oxalate, sodium citrate, and potassium benzoate; polyvalent metal salts such as aluminum chloride, aluminum bromide, aluminum sulfate, aluminum nitrate, sodium aluminum sulfate, potassium aluminum sulfate, aluminum acetate, barium chloride, barium bromide, barium iodide, barium oxide, barium nitrate, barium thiocyanate, calcium chloride, calcium bromide, calcium iodide, calcium nitrite, calcium nitrate, calcium dihydrogen phosphate, calcium thiocyanate, calcium benzoate, calcium acetate, calcium salicylate, calcium tartarate, calcium lactate, calcium fumarate, calcium citrate, copper chloride, copper bromide, copper sulfate, copper nitrate, copper acetate, iron chloride, iron bromide, iron iodide, iron sulfate, iron nitrate, iron oxalate, iron lactate, iron fumarate, iron citrate, magnesium chloride, magnesium bromide, magnesium iodide, magnesium sulfate, manganese nitrate, magnesium acetate, magnesium lactate, manganese chloride, manganese sulfate, manganese nitrate, magnesium dihydrogen phosphate, manganese acetate, manganese salicylate, manganese benzoate, manganese lactate, nickel chloride, nickel bromide, nickel sulfate, nickel nitrate, nickel acetate, tin sulfate, titanium chloride, zinc chloride, zinc bromide, zinc sulfate, zinc nitrate, zinc thiocyanate, and zinc acetate; and the like.

Examples of the organic amine compounds include primary, secondary, tertiary and quaternary amines, the salts of these amines, and the like. Specific examples thereof include tetraalkylammonium salts, alkylamine salts, benzalkonium salts, alkylpyridinium salts, imidazolium salts, polyamines, and the like; and more specific examples thereof include isopropylamine, isobutylamine, t-butylaamine, 2-ethylhexylamine, nonylamine, dipropylamine, diethylamine, trimethylamine, triethylamine, dimethylpropylamine, ethylenediamine, propylenediamine, hexamethylenediamine, diethylenetriamine, tetraethylenepentamine, diethanolamine, diethylethanolamine, triethanolamine, tetramethylammonium chloride, tetraethylammonium bromide, dihydroxyethylstearylamine, 2-heptadecenyl-hydroxyethylimidazoline, lauryldimethylbenzylammonium chloride, cetylpyridinium chloride, stearamidomethylpyridium chloride, diallyldimethylammonium chloride polymers, diallyamine polymers, monoallylamine polymers, and the sulfonium salts, onium salts such as phosphonium salts, and phosphoric acid esters of these compounds, and the like.

Examples of the organic acids include the styrene-styrenesulfonic acid copolymers, styrene-maleic acid copolymers, styrene-methacrylic acid copolymers, styrene-acrylic acid copolymers, vinylnaphthalene-maleic acid copolymers, vinylnaphthalene-methacrylic acid copolymers, vinylnaphthalene-acrylic acid copolymers, alkyl acrylate ester-acrylic acid copolymers, alkyl methacrylate ester-methacrylic acid copolymers, styrene-alkyl methacrylate ester-methacrylic acid copolymers, styrene-alkyl acrylate ester-acrylic acid copolymers, styrene-phenyl methacrylate ester-methacrylic acid copolymers, styrene-cyclohexyl methacrylate ester-methacrylic acid copolymers, and the like.

In the invention, the coagulant may be used alone or two or more coagulants may be mixed and used in combination. The amount of the coagulant added to the processing liquid is preferably in a range of approximately 0.01 to 30% by weight, more preferably in a range of approximately 0.1 to 15% by weight, and still more preferably in a range of approximately 0.25% to 10% by weight relative to a total amount of the processing liquid. When the addition amount of the coagulant is less than approximately 0.01% by weight in the processing liquid, it may lead to insufficient aggregation of pigment when ink and the processing liquid are brought into contact on the recording medium and deterioration in image density and worsening of ink bleeding and intercolor ink bleeding, while an addition amount of more than approximately 30% by weight may lead to deterioration in ejection property and improper ejection of the liquid.

On the other hand, a solvent may be the same solvent as that used in the ink, and other components may also be same components as those used in the ink as needed for obtaining desirable physical properties such as viscosity and surface tension.

Physical Properties of Ink and Processing Liquid

Physical properties which are preferable for the ink and the processing liquid used in the ink set of the present invention are herein explained.

When the inks are alkaline and the processing liquid is acidic, the pH of the inks is preferably approximately 7.5 to 10.5 and the pH of the processing liquid is approximately 2.5 to 7.0. On the other hand, when the inks are acidic and the processing is alkaline, the pH of the inks is preferably approximately 2.5 to 7.0, while the pH of the processing liquid is approximately 7.5 to 10.5. More preferably, the pH of the alkaline liquid is approximately 7.5 to 10.0, and still more preferably approximately 8.0 to 9.5. On the other hand, the pH of the acidic liquid is preferably in a range of approximately 3.0 to 7.0, and still more preferably approximately 3.5 to 6.0.

An acidic liquid having a pH of less than approximately 2.5 may occasionally dissolve the ink channel region of recording head, thereby causing malfunction of the recording head. Further, the pH of the acidic liquid exceeds approximately 7.0, it may occasionally lead to insufficient aggregation of pigment when the ink and the processing liquid are brought into contact with each other on a recording medium, resulting in deterioration in image density and worsening of ink bleeding and intercolor ink bleeding.

An alkaline liquid having a pH of less than approximately 7.5 may occasionally lead to deterioration in the long-term ejectability of the liquid, while that having a pH of more than approximately 10.5 may occasionally lead to dissolution of the ink channel region of recording head and thus, to malfunction of the recording head.

A surface tension of the ink is preferably approximately 20 mN/m to 60 mN/m, more preferably approximately 20 mN to 45 mN/m, and still more preferably approximately 25 mN/m to 35 mN/m. The surface tension of less than approximately 20 mN/m may result in flooding of liquid on the nozzle face of recording head and prohibit normal printing. On the other hand, the surface tension of more than approximately 60 mN/m may lead to deterioration in the permeability of ink and elongation of the drying period.

Viscosity of the ink is preferably approximately 1.2 m Pa·s to 8.0 m Pa·s, more preferably approximately 1.5 m Pa·s to 6.0 m Pass, and still more preferably approximately 1.8 m Pa·s to 4.5 m Pa·s. The ink viscosity of more than approximately 8.0 m Pa·s may result in deterioration in ejectability, while an ink viscosity of less than approximately 1.2 m Pa·s may result in deterioration of long-term ejectability.

The surface tension of the processing liquid is preferably approximately 20 mN/m to 45 mN/m, more preferably approximately 20 mN to 39 mN/m, still more preferably approximately 25 mN/m to 35 mN/m. The surface tension of less than approximately 20 mN/m may result in flooding of liquid on the nozzle face of recording head and prohibit normal printing. Alternatively, the surface tension of more than approximately 45 mN/m may lead to deterioration in the permeability of ink and elongation of the drying period.

The viscosity of the processing liquid is preferably approximately 1.2 m Pa·s to 8.0 m Pa s, more preferably approximately 1.5 m Pa·s to 6.0 m Pass, and still more preferably approximately 1.8 m Pa·s to 4.5 m Pass. When the viscosity of the first solution or the processing liquid is more than approximately 8.0 m Pass, the solution may have a lower ejectability, while the viscosity of less than approximately 1.2 m Pa·s may lead to deterioration in long-term ejectability.

Ink Jet Recording Method and Droplet Ejecting Apparatus

Hereinafter, an ink jet recording method using the ink set of the invention and a droplet ejecting apparatus using the ink set of the present invention will be described.

The ink jet recording method forms an image on a recording medium such as paper by ejecting the ink and the processing liquid thereon in such a manner that the ink and the processing liquid contact with each other. The ink set of the present invention is used as the ink and the processing liquid in the ink jet recording method.

The droplet ejecting apparatus according to the invention comprises at least a droplet ejecting unit that ejects droplets, and which forms an image by ejecting, from the droplet ejecting unit, droplets of the ink and droplets of the processing liquid onto a surface of a recording medium so that the ink and the processing liquid contact with each other. The ink set of the present invention is used as the ink and the processing liquid to the droplet ejecting apparatus. The droplet ejecting unit may be any one of the so-called piezoelectric process that ejects the droplets by application of a pressure to the droplets and the so-called thermal process that ejects droplets by application of a heat to the droplet.

The droplet ejecting apparatus according to the invention is particularly preferably an ink jet recording apparatus that is used in office or at home, or alternatively an ink jet recording apparatus that is used in industrial applications. The following description is based on an assumption that the droplet ejecting apparatus according to the invention is an ink jet recording apparatus and the droplet ejecting unit is a recording head installed in the ink jet recording apparatus.

The ink jet recording apparatus according to the invention may have an ink jet recording ink tank (hereinafter, referred to as “ink tank”) which is detachably connected to an ink jet recording apparatus having a recording head, and supplies the inks and a processing liquid to the recording head. The ink set according to the invention may be contained in the ink tank.

An ordinary two-liquid printing apparatus that can use the ink set of the invention can be used as the ink jet recording apparatus for the invention. The ink jet recording apparatus may have an additional heater or the like for controlling ink drying or an intermediate transfer structure for ejecting (printing) the ink and the processing liquid onto an intermediate carrier body and a transferring the thus formed image to a recording medium such as paper.

The ink tank is detachably connected to the ink jet recording apparatus having a recording head, and any one of known ink tanks may be used as long as it can supply the ink (and the processing liquid) to the recording head in a state of being connected to the ink jet recording apparatus. The ink set according to the invention is stored in the ink tank.

The ratio of the amount of the ink applied on the recording medium surface per unit area to that the amount of the processing liquid applied on the recording medium surface per unit area (amount of ejected ink: amount of ejected processing liquid) is preferably in a range of approximately 1.2:1 to 20:1 by weight.

Although the ratio of the amount of the ejected processing liquid to the amount of the ejected ink of lower than the range of approximately 1.2:1 is advantageous in preventing troubles such as curl and cockle, an excessively lower rate reduces the advantageous effects of the processing liquid, occasionally resulting in deterioration in image density and image resolution. On the other hand, the ratio of the amount of ejected processing liquid of higher than the range of approximately 20:1 may lead to more frequent generation of curl and cockle, although the image density and the image definition are favorable. The ratio is more preferable in a range of approximately 1:16 to 1:2 and still more preferably in a range of approximately 1:10 to 1:3.

In the ink jet recording method (and apparatus) according to the invention, both of the weight of one drop of the ink and the weight of one drop of the processing liquid) are preferably approximately 25 ng or less, more preferably, approximately 0.5 ng to 20 ng, and still more preferably approximately 2 ng to 8 ng. The weight of the liquid per one drop of more than approximately 25 ng may lead to worsening of ink bleeding. It is because the contact angle of the ink (and the processing liquid) to the recording medium changes depending on the drop amount, and a drop tends to spread more over a paper in the surface direction when the drop amount increases.

In an inkjet apparatus ejecting multiple droplets different in volume from one nozzle, the drop amount refers to as the minimum amount of droplet allowing printing.

In addition, the ink and the processing liquids are applied on a recording medium so as to bring into contact with each other, and the ink and the processing liquid may be ejected so as to be either close to each other or overlapped, as long as they become in contact with each other.

The order of ejection of the ink and the processing liquid onto the recording medium is not particularly limited, and either of them may be applied first or both solutions may be applied at the same time. It is preferable applied on the recording medium in the order that the processing liquid firstly applied and the ink is then applied. By the application of the processing liquid in advance enables more effective aggregation of the colorants in the inkjet ink. The ink may be applied anytime after application of the processing liquid. Preferably, the interval from finishing the application to the application of the ink is approximately 1 second or less, and more preferably approximately 0.5 second or less.

In the ink jet recording apparatus according to the invention, the inks (and the processing liquid) are preferably replenished (supplied) to the recording head from the respective ink tanks (including a processing liquid tank) filled with the ink (or the processing liquid). The ink tanks are preferably detachable from the main apparatus, and the inks and the processing liquid are replenished more easily when the ink tanks are exchanged as cartridge system.

Hereinafter, favorable embodiments of the ink jet recording apparatus according to the invention will be described in detail with reference to drawings. In the Figures, the same codes are allocated to the units having essentially the same functions, and thus, duplicated description is avoided.

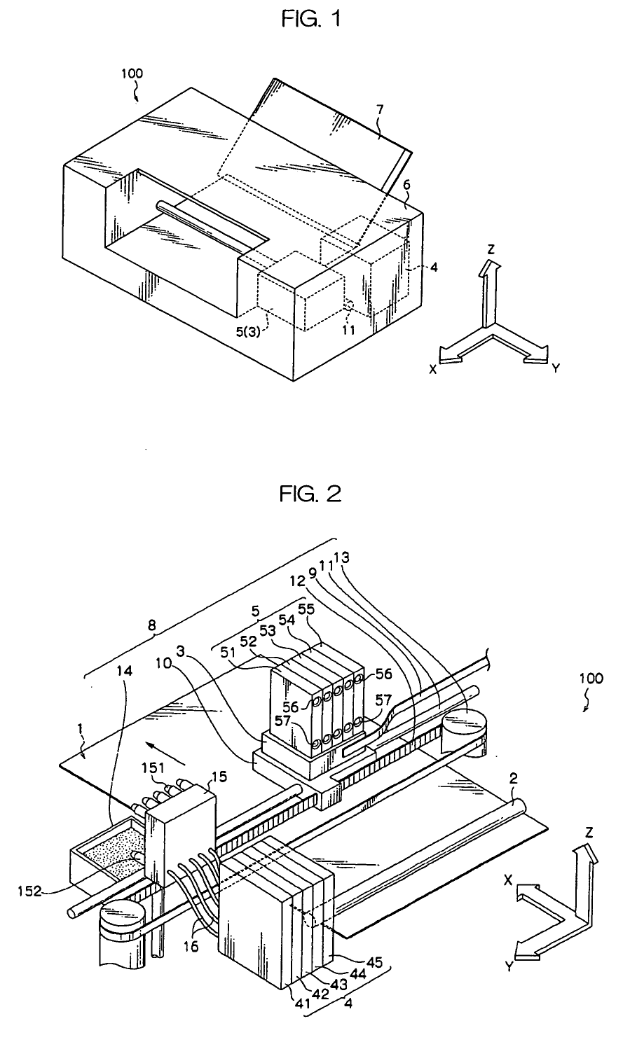

FIG. 1 is a perspective view illustrating the configuration of an exterior of a favorable embodiment of an ink jet recording apparatus according to the invention. FIG. 2 is a perspective view illustrating the basic configuration of the interior of the ink jet recording apparatus (hereinafter, referred to as image-forming apparatus) shown in FIG. 1.

In an embodiment, an image-forming apparatus 100 has a configuration in which an image is formed by operations based on the ink jet recording method according to the invention described above. As shown in FIGS. 1 and 2, the image-forming apparatus 100 mainly has an outside cover 6, a tray 7 carrying a particular amount of a recording medium 1 such as plain paper, a conveyor roller (conveying unit) 2 of conveying the recording medium 1 one by one into the image-forming apparatus 100, an image-forming part 8 (image-forming unit) of forming an image by ejecting inks and a processing liquid onto the surface of the recording medium 1, and a main ink tank 4 of supplying inks and a processing liquid to a sub-ink tank 5 in the image-forming unit 8 therefrom.

The conveyor roller 2 is a paper-feeding mechanism consisting of a pair of rotatable rollers that is installed in the image-forming apparatus 100, which holds a recording medium 1 stored in the tray 7 and convey a particular amount of the recording media 1 at a particular timing one by one into the image-forming apparatus 100.

The image-forming part 8 forms an ink image on the surface of the recording medium 1. The image-forming part 8 mainly has a recording head 3, a sub-ink tank 5, a power/signal cable 9, a carriage 10, a guide rod 11, a timing belt 12, drive pulleys 13, and a maintenance unit 14.

The sub-ink tank 5 has sub-ink tanks 51, 52, 53, 54, and 55 respectively receiving inks different in color and a processing liquid for ejection from the recording head. For example, four inks in different color, black ink (K), yellow ink (Y), magenta ink (M), and cyan ink (C), and a processing liquid are fed from the main ink tank 4 and filled in respective sub-ink tanks.

Each of the sub-ink tanks 51 to 55 has an exhaust vent 56 and a replenishing hole 57. When the recording head 3 moves to a stand-by position (or replenishing position), a ventilation pin 151 and a replenishing pin 152 in a replenishing apparatus 15 are joined and connected to the exhaust vent 56 and the replenishing hole 57, and thus, the entire sub-ink tank 5 and the replenishing apparatus 15 are joined and connected to each other. The replenishing apparatus 15 is also connected to the main ink tank 4 via replenishing tubes 16, and the inks and the processing liquid are replenished by the replenishing apparatus 15 from the main ink tank 4 through the replenishing holes 57 to the sub-ink tank 5.

The main ink tank 4 also has main ink tanks 41, 42, 43, 44, and 45 respectively storing inks different in color and a processing liquid. For example, as the first liquids, black ink (K), yellow ink (Y), magenta ink (M) and cyan ink (C), and as the second liquid, a processing liquid are filled respectively therein, and these main ink tanks respectively are detachably installed in the image-forming apparatus 100.

In addition, a power supply/signal cable 9 and the sub-ink tank 5 are connected to recording head 3, and when external recording image information is inputted through the power supply/signal cable 9 to the recording head 3, the recording head 3 withdraws a particular amount of ink from each sub-ink tank 5 and ejects it on the surface of recording medium based on the recording image information. The power supply/signal cable 9 also has a role of supplying power needed for driving the recording head 3 to the recording head 3, in addition to the recording image information.

The recording head 3 is placed and held on the carriage 10, and a guide rod 11 and a timing belt 12 supported by drive pulleys 13 are connected to the carriage 10. In such a configuration, the recording head 3 can move along the guide rod 11 in the direction parallel to the surface of the recording medium 1 and in the direction Y (main scanning direction) perpendicular to the conveyor direction X (secondary scanning direction) of the recording medium 1.

The image-forming apparatus 100 has control means (not shown in the Figure) of determining the timing of driving the recording head 3 and carriage 10 based on the recording image information. In this manner, it is possible to form continuously an image in a particular region on the surface of the recording medium 1 traveling in the conveyor direction X at a particular speed, based on the recording image information.

A maintenance unit 14 is connected to a pressure reducing device (not shown in the Figure) via a tube. In addition, the maintenance unit 14 is connected to the nozzle region of the recording head 3, and plays a role of withdrawing ink from the nozzle of the recording head 3 by bringing the nozzle of recording head 3 into a reduced-pressure state. By installation of the maintenance unit 14, it becomes possible to remove the undesirable ink deposited on the nozzle during operation of the image-forming apparatus 100 and reduce vaporization of ink from nozzles in the stand-by mode as needed.

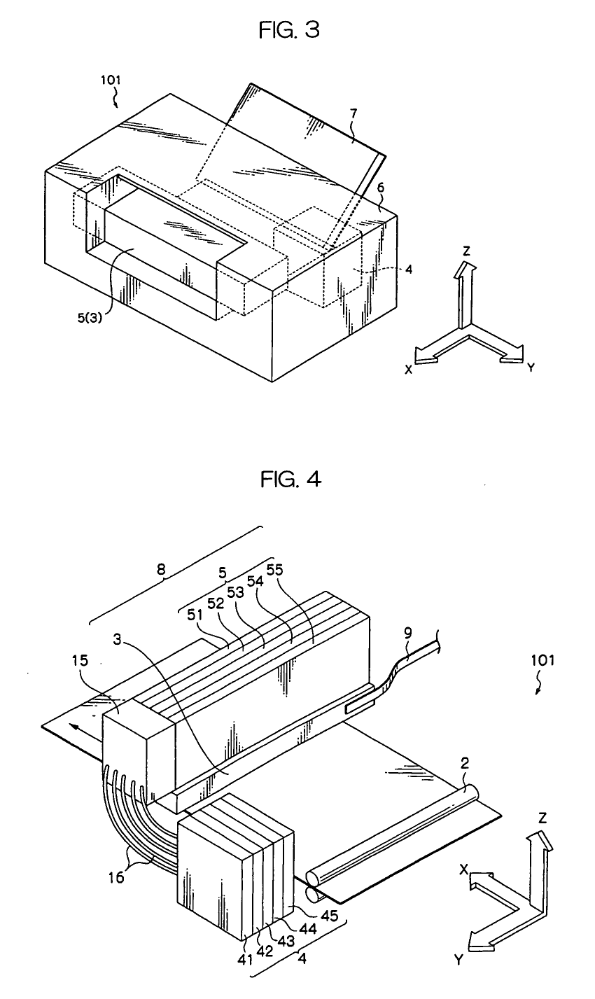

FIG. 3 is a perspective view illustrating the exterior configuration of another favorable embodiment of the ink jet recording apparatus according to the invention. FIG. 4 is a perspective view illustrating the basic configuration of the interior of the ink jet recording apparatus (hereinafter, referred to as image-forming apparatus) shown in FIG. 3. In an embodiment, an image-forming apparatus 101 has a configuration in which an image is formed by operation based on the ink jet recording method according to the invention described above.

The image-forming apparatus 101 shown in FIGS. 3 and 4 has a recording head 3 having the same width as or larger than that of the recording medium 1, but does not have a carriage mechanism, and has a paper-feeding mechanism in the secondary scanning direction (conveyor direction of recording medium 1, indicated by arrow X); and, for example, a belt-shaped paper-feeding mechanism may be used instead of the conveyor roller 2 shown in this embodiment.

Although not shown in the Figure, nozzles ejecting inks of various colors (including a processing liquid) are placed sequentially in the secondary scanning direction, together with sub-ink tanks 51 to 55 sequentially arranged in the secondary scanning direction (conveyor direction of recording medium 1, indicated by arrow X). Other configuration is the same as that of the image-forming apparatus 100 shown in FIGS. 1 and 2, and description thereof is omitted. Although the sub-ink tank 5 is shown in the Figure as it is always connected to a replenishing apparatus 15 because the recording head 3 does not move, the tank may be connected to the replenishing apparatus 15 only when the inks are replenished.

In the image-forming apparatus 101 shown in FIGS. 3 and 4, printing in the width direction of the recording medium 1 (main scanning direction) is performed all at once by the recording head 3, and thus, the apparatus is simpler in structure than those having a carriage mechanism and faster in printing speed.

### EXAMPLES

Examples of the present invention will be described below, however, the invention is not restricted thereto.

### Examples 1 to 18 and Comparative Examples 1 to 9

Preparation of Ink

Ink 1

Ink 1 used in Example 1 is prepared so as to have the following composition.

| | | |
|---|---|---|
| Pigment (carbon black having no surface functional | 3 | wt % |
| group, trade name: MOGUL ® L, manufactured by Cabot | | |
| Corporation) | | |
| Polymer dispersant (styrene-methacrylic acid copolymer | 0.6 | wt % |
| having Mw of 100,000 and neutralized with NaOH, acid | | |
| value: 100 mg-KOH/g, neutralization degree: 0.1) | | |
| Diethyleneglycol | 10 | wt % |
| Diethyleneglycol monobutylether | 3 | wt % |
| Ethyleneoxide adduct of acetyleneglycol | 1 | wt % |

| | |
|---|---|
| Deionized water | Remaining |
| | portion |

In the preparation of the ink 1, the pigment is utilized in a form of a pigment dispersion liquid which is prepared in advance by the following process. Inks used in Examples 2 to 18 and Comparative examples 1 to 9 described below are also formed by using pigment dispersion liquid prepared in a similar matter.

Preparation of Pigment Dispersion Liquid

6 parts by weight of the alkali-neutralized salt of polymer dispersant is added to 30 parts by weight of the pigment, and deionized water is further added thereto so as to provide 6 parts by weight of a mixture solution. The mixture solution is subjected to ultrasonic wave by an ultrasonic homogenizer so as to disperse the pigment, and a pigment dispersion liquid is thus obtained.

Ink 2

Ink 2 used in Example 2 is prepared so as to have the following composition.

| | | |
|---|---|---|
| Pigment (trade name: MOGUL ® L, described above) | 3 | wt % |
| Polymer dispersant (styrene-methacrylic acid copolymer | 0.6 | wt % |
| having Mw of 30,000 and neutralized with NaOH, acid | | |
| value: 100 mg-KOH/g, neutralization degree: 0.6) | | |
| Diethyleneglycol | 10 | wt % |
| Diethyleneglycol monobutylether | 3 | wt % |
| Ethyleneoxide adduct of acetyleneglycol | 1 | wt % |

| | |
|---|---|
| Deionized water | Remaining |
| | portion |

Ink 3

Ink 3 used in Example 3 is prepared so as to have the following composition.

| | | |
|---|---|---|
| Pigment (trade name: MOGUL ® L, described above) | 3 | wt % |
| Polymer dispersant (styrene-methacrylic acid copolymer | 0.6 | wt % |
| having Mw of 30,000 and neutralized with NaOH, acid | | |
| value: 400 mg-KOH/g, neutralization degree: 0.15) | | |
| Diethyleneglycol | 10 | wt % |
| Diethyleneglycol monobutylether | 3 | wt % |
| Ethyleneoxide adduct of acetyleneglycol | 1 | wt % |

| | |
|---|---|
| Deionized water | Remaining |
| | portion |

Ink 4

Ink 4 used in Example 4 is prepared so as to have the following composition.

| | | |
|---|---|---|
| Pigment (trade name: MOGUL ® L, described above) | 3 | wt % |
| Polymer dispersant (styrene-methacrylic acid copolymer | 1.2 | wt % |
| having Mw of 30,000 and neutralized with NaOH, acid | | |
| value: 400 mg-KOH/g, neutralization degree: 0.5) | | |
| Diethyleneglycol | 10 | wt % |
| Diethyleneglycol monobutylether | 3 | wt % |
| Ethyleneoxide adduct of acetyleneglycol | 1 | wt % |

| | |
|---|---|
| Deionized water | Remaining |
| | portion |

Ink 5

Ink 5 used in Example 5 is prepared so as to have the following composition.

| | | |
|---|---|---|
| Pigment (trade name: MOGUL ® L, described above) | 3 | wt % |
| Polymer dispersant (styrene-methacrylic acid copolymer | 3 | wt % |
| having Mw of 8,000 and neutralized with NaOH, acid | | |
| value: 100 mg-KOH/g, neutralization degree: 0.1) | | |
| Diethyleneglycol | 10 | wt % |
| Diethyleneglycol monobutylether | 3 | wt % |
| Ethyleneoxide adduct of acetyleneglycol | 1 | wt % |

| | |
|---|---|
| Deionized water | Remaining |
| | portion |

Ink 6

Ink 6 used in Example 6 is prepared so as to have the following composition.

| | | |
|---|---|---|
| Pigment (trade name: MOGUL ® L, described above) | 3 | wt % |
| Polymer dispersant (styrene-methacrylic acid copolymer | 3 | wt % |
| having Mw of 30,000 and neutralized with NaOH, acid | | |
| value: 400 mg-KOH/g, neutralization degree: 0.6) | | |
| Diethyleneglycol | 10 | wt % |
| Diethyleneglycol monobutylether | 3 | wt % |
| Ethyleneoxide adduct of acetyleneglycol | 1 | wt % |

| | |
|---|---|
| Deionized water | Remaining |
| | portion |

Ink 7

Ink 7 used in Example 7 is prepared so as to have the following composition.

| | | |
|---|---|---|
| Pigment (trade name: MOGUL ® L, described above) | 5 | wt % |
| Polymer dispersant (styrene-methacrylic acid copolymer | 1 | wt % |
| having Mw of 40,000 and neutralized with triethanol- | | |
| amine, acid value: 100 mg-KOH/g, neutralization degree: 0.1) | | |
| Diethyleneglycol | 10 | wt % |
| Diethyleneglycol monobutylether | 3 | wt % |
| Ethyleneoxide adduct of acetyleneglycol | 1 | wt % |

| | |
|---|---|
| Deionized water | Remaining |
| | portion |

Ink 8

Ink 8 used in Example 8 is prepared so as to have the following composition.

| | | |
|---|---|---|
| Pigment (trade name: MOGUL ® L, described above) | 5 | wt % |
| Polymer dispersant (styrene-methacrylic acid copolymer | 5 | wt % |
| having Mw of 40,000 and neutralized with NaOH, acid | | |
| value: 400 mg-KOH/g, neutralization degree: 0.1) | | |
| Diethyleneglycol | 10 | wt % |
| Diethyleneglycol monobutylether | 3 | wt % |
| Ethyleneoxide adduct of acetyleneglycol | 1 | wt % |

| | |
|---|---|
| Deionized water | Remaining |
| | portion |

Ink 9

Ink 9 used in Example 9 is prepared so as to have the following composition.

| | | |
|---|---|---|
| Pigment (trade name: MOGUL ® L, described above) | 15 | wt % |
| Polymer dispersant (styrene-methacrylic acid copolymer | 3 | wt % |
| having Mw of 30,000 and neutralized with NaOH, acid | | |
| value: 100 mg-KOH/g, neutralization degree: 0.1) | | |
| Diethyleneglycol | 10 | wt % |
| Diethyleneglycol monobutylether | 3 | wt % |
| Ethyleneoxide adduct of acetyleneglycol | 1 | wt % |

| | |
|---|---|
| Deionized water | Remaining |
| | portion |

Ink 10

Ink 10 used in Example 10 is prepared so as to have the following composition.

| | | |
|---|---|---|
| Pigment (trade name: MOGUL ® L, described above) | 15 | wt % |
| Polymer dispersant (styrene-methacrylic acid copolymer | 3 | wt % |
| having Mw of 30,000 and neutralized with NaOH, acid | | |
| value: 200 mg-KOH/g, neutralization degree: 0.6) | | |
| Diethyleneglycol | 10 | wt % |
| Diethyleneglycol monobutylether | 3 | wt % |
| Ethyleneoxide adduct of acetyleneglycol | 1 | wt % |

| | |
|---|---|
| Deionized water | Remaining |
| | portion |

Ink 11

Ink 11 used in Example 11 is prepared so as to have the following composition.

| | | |
|---|---|---|
| Pigment (trade name: MOGUL ® L, described above) | 15 | wt % |
| Polymer dispersant (styrene-methacrylic acid copolymer | 3 | wt % |
| having Mw of 30,000 and neutralized with NaOH, acid | | |
| value: 400 mg-KOH/g, neutralization degree: 0.15) | | |
| Diethyleneglycol | 10 | wt % |
| Diethyleneglycol monobutylether | 3 | wt % |
| Ethyleneoxide adduct of acetyleneglycol | 1 | wt % |

| | |
|---|---|
| Deionized water | Remaining |
| | portion |

Ink 12

Ink 12 used in Example 12 is prepared so as to have the following composition.

| | | |
|---|---|---|
| Pigment (trade name: MOGUL ® L, described above) | 15 | wt % |
| Polymer dispersant (styrene-methacrylic acid copolymer | 3 | wt % |
| having Mw of 30,000 and neutralized with NaOH, acid | | |
| value: 400 mg-KOH/g, neutralization degree: 0.6) | | |
| Diethyleneglycol | 10 | wt % |
| Diethyleneglycol monobutylether | 3 | wt % |
| Ethyleneoxide adduct of acetyleneglycol | 1 | wt % |

| | |
|---|---|
| Deionized water | Remaining |
| | portion |

Ink 13

Ink 13 used in Example 13 is prepared so as to have the following composition.

| | | |
|---|---|---|
| Pigment (trade name: MOGUL ® L, described above) | 15 | wt % |
| Polymer dispersant (styrene-methacrylic acid copolymer | 15 | wt % |
| having Mw of 30,000 and neutralized with NaOH, acid | | |
| value: 100 mg-KOH/g, neutralization degree: 0.1) | | |
| Diethyleneglycol | 10 | wt % |
| Diethyleneglycol monobutylether | 3 | wt % |
| Ethyleneoxide adduct of acetyleneglycol | 1 | wt % |

| | |
|---|---|
| Deionized water | Remaining |
| | portion |

Ink 14

Ink 14 used in Example 14 is prepared so as to have the following composition.

| | | |
|---|---|---|
| Pigment (trade name: MOGUL ® L, described above) | 15 | wt % |
| Polymer dispersant (styrene-methacrylic acid copolymer | 15 | wt % |
| having Mw of 30,000 and neutralized with NaOH, acid | | |
| value: 300 mg-KOH/g, neutralization degree: 0.1) | | |
| Diethyleneglycol | 10 | wt % |
| Diethyleneglycol monobutylether | 3 | wt % |
| Ethyleneoxide adduct of acetyleneglycol | 1 | wt % |

| | |
|---|---|
| Deionized water | Remaining |
| | portion |

Ink 15

Ink 15 used in Example 15 is prepared so as to have the following composition.

| | | |
|---|---|---|
| Pigment (trade name: MOGUL ® L, described above) | 3 | wt % |
| Polymer dispersant (styrene-methacrylic acid copolymer | 0.6 | wt % |
| having Mw of 120,000 and neutralized with NaOH, acid | | |
| value: 400 mg-KOH/g, neutralization degree: 0.6) | | |
| Diethyleneglycol | 10 | wt % |
| Diethyleneglycol monobutylether | 3 | wt % |
| Ethyleneoxide adduct of acetyleneglycol | 1 | wt % |

| | |
|---|---|
| Deionized water | Remaining |
| | portion |

Ink 16

Ink 16 used in Example 16 is prepared so as to have the following composition.

| | | |
|---|---|---|
| Pigment (trade name: MOGUL ® L, described above) | 5 | wt % |
| Polymer dispersant (styrene-methacrylic acid copolymer | 2 | wt % |
| having Mw of 30,000 and neutralized with triethanol- | | |
| amine, acid value: 200 mg-KOH/g, neutralization | | |
| degree: 0.15) | | |
| Diethyleneglycol | 10 | wt % |
| Diethyleneglycol monobutylether | 3 | wt % |
| Ethyleneoxide adduct of acetyleneglycol | 1 | wt % |

| | |
|---|---|
| Deionized water | Remaining |
| | portion |

Ink 17

Ink 17 used in Example 17 is prepared so as to have the following composition.

| | | |
|---|---|---|
| Pigment (trade name: MOGUL ® L, described above) | 5 | wt % |
| Polymer dispersant (styrene-methacrylic acid copolymer | 1.25 | wt % |
| having Mw of 30,000 and neutralized with NaOH, acid | | |
| value: 300 mg-KOH/g, neutralization degree: 0.5) | | |
| Diethyleneglycol | 10 | wt % |
| Diethyleneglycol monobutylether | 3 | wt % |
| Ethyleneoxide adduct of acetyleneglycol | 1 | wt % |

| | |
|---|---|
| Deionized water | Remaining |
| | portion |

Ink 18

Ink 18 used in Example 18 is prepared so as to have the following composition.

| | | |
|---|---|---|
| Pigment (trade name: MOGUL ® L, described above) | 5 | wt % |
| Polymer dispersant (styrene-methacrylic acid copolymer | 4 | wt % |
| having Mw of 30,000 and neutralized with NaOH, acid | | |
| value: 300 mg-KOH/g, neutralization degree: 0.15) | | |
| Diethyleneglycol | 10 | wt % |
| Diethyleneglycol monobutylether | 3 | wt % |
| Ethyleneoxide adduct of acetyleneglycol | 1 | wt % |

| | |
|---|---|
| Deionized water | Remaining |
| | portion |

Ink 19

Ink 19 used in Comparative example 1 is prepared so as to have the following composition.

| | | |
|---|---|---|
| Pigment (trade name: MOGUL ® L, described above) | 3 | wt % |
| Polymer dispersant (styrene-methacrylic acid copolymer | 0.6 | wt % |
| having Mw of 30,000 and neutralized with NaOH, acid | | |
| value: 100 mg-KOH/g, neutralization degree: 0.05) | | |
| Diethyleneglycol | 10 | wt % |
| Diethyleneglycol monobutylether | 3 | wt % |
| Ethyleneoxide adduct of acetyleneglycol | 1 | wt % |

| | |
|---|---|
| Deionized water | Remaining |
| | portion |

Ink 20

Ink 20 used in Comparative example 2 is prepared so as to have the following composition.

| | | |
|---|---|---|
| Pigment (trade name: MOGUL ® L, described above) | 3 | wt % |
| Polymer dispersant (styrene-methacrylic acid copolymer | 0.6 | wt % |
| having Mw of 30,000 and neutralized with NaOH, acid | | |
| value: 100 mg-KOH/g, neutralization degree: 0.65) | | |
| Diethyleneglycol | 10 | wt % |
| Diethyleneglycol monobutylether | 3 | wt % |
| Ethyleneoxide adduct of acetyleneglycol | 1 | wt % |

| | |
|---|---|
| Deionized water | Remaining |
| | portion |

Ink 21

Ink 21 used in Comparative example 3 is prepared so as to have the following composition.

| | | |
|---|---|---|
| Pigment (trade name: MOGUL ® L, described above) | 3 | wt % |
| Polymer dispersant (styrene-methacrylic acid copolymer | 0.6 | wt % |
| having Mw of 30,000 and neutralized with NaOH, acid | | |
| value: 500 mg-KOH/g, neutralization degree: 0.1) | | |
| Diethyleneglycol | 10 | wt % |
| Diethyleneglycol monobutylether | 3 | wt % |
| Ethyleneoxide adduct of acetyleneglycol | 1 | wt % |

| | |
|---|---|
| Deionized water | Remaining |
| | portion |

Ink 22

Ink 22 used in Comparative example 4 is prepared so as to have the following composition.

| | | |
|---|---|---|
| Pigment (trade name: MOGUL ® L, described above) | 3 | wt % |
| Polymer dispersant (styrene-methacrylic acid copolymer | 0.6 | wt % |
| having Mw of 120,000 and neutralized with NaOH, acid | | |
| value: 400 mg-KOH/g, neutralization degree: 0.65) | | |
| Diethyleneglycol | 10 | wt % |
| Diethyleneglycol monobutylether | 3 | wt % |
| Ethyleneoxide adduct of acetyleneglycol | 1 | wt % |

| | |
|---|---|
| Deionized water | Remaining |
| | portion |

Ink 23

Ink 23 used in Comparative example 5 is prepared so as to have the following composition.

| | | |
|---|---|---|
| Pigment (trade name: MOGUL ® L, described above) | 3 | wt % |
| Polymer dispersant (styrene-methacrylic acid copolymer | 0.45 | wt % |
| having Mw of 30,000 and neutralized with NaOH, acid | | |
| value: 100 mg-KOH/g, neutralization degree: 0.1) | | |
| Diethyleneglycol | 10 | wt % |
| Diethyleneglycol monobutylether | 3 | wt % |
| Ethyleneoxide adduct of acetyleneglycol | 1 | wt % |

| | |
|---|---|
| Deionized water | Remaining |
| | portion |

Ink 24

Ink 24 used in Comparative example 6 is prepared so as to have the following composition.

| | | |
|---|---|---|
| Pigment (trade name: MOGUL ® L, described above) | 3 | wt % |
| Polymer dispersant (styrene-methacrylic acid copolymer | 3.3 | wt % |
| having Mw of 30,000 and neutralized with NaOH, acid | | |
| value: 100 mg-KOH/g, neutralization degree: 0.1) | | |
| Diethyleneglycol | 10 | wt % |
| Diethyleneglycol monobutylether | 3 | wt % |
| Ethyleneoxide adduct of acetyleneglycol | 1 | wt % |

| | |
|---|---|
| Deionized water | Remaining |
| | portion |

Ink 25

Ink 25 used in Comparative example 7 is prepared so as to have the following composition.

| | | |
|---|---|---|
| Pigment (trade name: MOGUL ® L, described above) | 15 | wt % |
| Polymer dispersant (styrene-methacrylic acid copolymer | 16.5 | wt % |
| having Mw of 40,000 and neutralized with triethanolamine, | | |
| acid value: 100 mg-KOH/g, neutralization degree: 0.1) | | |
| Diethyleneglycol | 10 | wt % |
| Diethyleneglycol monobutylether | 3 | wt % |
| Ethyleneoxide adduct of acetyleneglycol | 1 | wt % |

| | |
|---|---|
| Deionized water | Remaining |
| | portion |

Ink 26

Ink 26 used in Comparative example 8 is prepared so as to have the following composition.

| | | |
|---|---|---|
| Pigment (trade name: MOGUL ® L, described above) | 15 | wt % |
| Polymer dispersant (styrene-methacrylic acid copolymer | 2.25 | wt % |
| having Mw of 40,000 and neutralized with NaOH, acid | | |
| value: 100 mg-KOH/g, neutralization degree: 0.1) | | |
| Diethyleneglycol | 10 | wt % |
| Diethyleneglycol monobutylether | 3 | wt % |
| Ethyleneoxide adduct of acetyleneglycol | 1 | wt % |

| | |
|---|---|
| Deionized water | Remaining |
| | portion |

Ink 27

Ink 27 used in Comparative example 9 is prepared so as to have the following composition.

| | | |
|---|---|---|
| Pigment (trade name: MOGUL ® L, described above) | 15 | wt % |
| Polymer dispersant (styrene-methacrylic acid copolymer | 3 | wt % |
| having Mw of 30,000 and neutralized with NaOH, acid | | |
| value: 80 mg-KOH/g, neutralization degree: 0.1) | | |
| Diethyleneglycol | 10 | wt % |
| Diethyleneglycol monobutylether | 3 | wt % |
| Ethyleneoxide adduct of acetyleneglycol | 1 | wt % |

| | |
|---|---|
| Deionized water | Remaining |
| | portion |

Preparation of Processing Liquid

A processing liquid (processing liquid 1) is prepared so as to have the following composition.

| | | |
|---|---|---|
| Coagulating agent (2-pyrrolidone-5-carboxylic acid) | 1 | wt % |
| Diethyleneglycol | 20 | wt % |
| Ethyleneoxide adduct of acetyleneglycol | 1 | wt % |
| Sodium hydroxide | 0.25 | wt % |

| | |
|---|---|
| Deionized water | Remaining |
| | portion |

Evaluation

The inks and the processing liquids described above are combined as are shown in the following Tables 1 and 2 so as to provide Examples 1 to 18 and Comparative Examples 1 to 9. Physical properties of the resins (polymer dispersants) used in preparation of the inks are also summarized in Tables 1 and 2.

A solid image of 20.5 cm×29 cm in size is successively printed on each of 100 sheets of a recording paper (trade name: FX-P PAPER, manufactured by Fuji Xerox Co., Ltd.) by ejecting the processing liquid and then the ink thereon by an ink jet recording apparatus manufactured by Fuji Xerox Co., Ltd. equipped with an experimentally-prepared recording head having 256 nozzles and a resolution of 800 dpi for piezoelectric process. The 100 sheets-printing process is repeated three times with intervals for maintenance of the nozzle face of recording head. The ejectability, the image density, and the drying property during printing in Examples 1 to 18 and Comparative Examples 1 to 9 are evaluated. Results are summarized in Tables 1 and 2. The amounts of the residues in the supernatant liquids obtained after centrifugation of the inks described above are also summarized in Tables 1 and 2.

TABLE 1

| | | | | | Amount of | | | | | | | |
|---|---|---|---|---|---|---|---|---|---|---|---|---|
| | | | Amount | Amount | Resin (wt % | Acid | Neu- | | Mw of | | | |
| | | | of | of | relative to | value | trali- | | Polymer | | | |
| | Ink set | | Pigment | Residue | amount of | (mg- | zation | Neu- | dis- | Eject- | Image | Drying |
| | Ink | Processing liquid | (wt %) | (wt %) | pigment) | KOH/g) | degree | tralizer | persant | ability | density | property |
| Example 1 | Ink 1 | Processing liquid 1 | 3 | 4 | 20 | 100 | 0.1 | NaOH | 100,000 | E | A | A |
| Example 2 | Ink 2 | Processing liquid 1 | 3 | 4 | 20 | 100 | 0.6 | NaOH | 30,000 | A | A | A |
| Example 3 | Ink 3 | Processing liquid 1 | 3 | 3 | 20 | 400 | 0.15 | NaOH | 30,000 | E | A | A |
| Example 4 | Ink 4 | Processing liquid 1 | 3 | 3 | 40 | 400 | 0.5 | NaOH | 30,000 | E | A | A |
| Example 5 | Ink 5 | Processing liquid 1 | 3 | 4 | 100 | 100 | 0.1 | NaOH | 8,000 | E | A | A |
| Example 6 | Ink 6 | Processing liquid 1 | 3 | 4 | 100 | 400 | 0.6 | NaOH | 30,000 | A | A | A |
| Example 7 | Ink 7 | Processing liquid 1 | 5 | 4 | 20 | 100 | 0.1 | Tri- | 40,000 | E | A | A |
| | | | | | | | | ethanol- | | | | |
| | | | | | | | | amine | | | | |
| Example 8 | Ink 8 | Processing liquid 1 | 5 | 4 | 100 | 400 | 0.1 | NaOH | 40,000 | E | A | A |
| Example 9 | Ink 9 | Processing liquid 1 | 15 | 4 | 20 | 100 | 0.1 | NaOH | 30,000 | E | A | A |
| Example 10 | Ink 10 | Processing liquid 1 | 15 | 3 | 20 | 200 | 0.6 | NaOH | 30,000 | A | A | A |
| Example 11 | Ink 11 | Processing liquid 1 | 15 | 5 | 20 | 400 | 0.15 | NaOH | 30,000 | E | B | A |
| Example 12 | Ink 12 | Processing liquid 1 | 15 | 6 | 20 | 400 | 0.6 | NaOH | 30,000 | A | B | A |
| Example 13 | Ink 13 | Processing liquid 1 | 15 | 7 | 100 | 100 | 0.1 | NaOH | 30,000 | A | A | A |
| Example 14 | Ink 14 | Processing liquid 1 | 15 | 8 | 100 | 300 | 0.1 | NaOH | 30,000 | A | B | A |
| Example 15 | Ink 15 | Processing liquid 1 | 3 | 5 | 20 | 400 | 0.6 | NaOH | 120,000 | B | B | A |
| Example 16 | Ink 16 | Processing liquid 1 | 5 | 3 | 40 | 200 | 0.15 | Tri- | 30,000 | * | A | A |
| | | | | | | | | ethanol- | | | | |
| | | | | | | | | amine | | | | |
| Example 17 | Ink 17 | Processing liquid 1 | 5 | 4 | 25 | 300 | 0.5 | NaOH | 30,000 | * | A | A |
| Example 18 | Ink 18 | Processing liquid 1 | 5 | 4 | 80 | 300 | 0.15 | NaOH | 30,000 | * | A | A |

TABLE 2

| | | | | | Amount of | | | | | | | |
|---|---|---|---|---|---|---|---|---|---|---|---|---|
| | | | Amount | Amount | Resin (wt % | Acid | Neu- | | Mw of | | | |
| | | | of | of | relative to | value | trali- | | Polymer | | | |
| | Ink set | | Pigment | Residue | amount of | (mg- | zation | Neu- | dis- | Eject- | Image | Drying |
| | Ink | Processing liquid | (wt %) | (wt %) | pigment) | KOH/g) | degree | tralizer | persant | ability | density | property |
| Comparative | Ink 19 | Processing liquid 1 | 3 | 5 | 20 | 100 | 0.05 | NaOH | 30,000 | C | A | A |
| example 1 | | | | | | | | | | | | |
| Comparative | Ink 20 | Processing liquid 1 | 3 | 3 | 20 | 100 | 0.65 | NaOH | 30,000 | A | B | C |
| example 2 | | | | | | | | | | | | |
| Comparative | Ink 21 | Processing liquid 1 | 3 | 4 | 20 | 500 | 0.1 | NaOH | 30,000 | B | B | A |
| example 3 | | | | | | | | | | | | |
| Comparative | Ink 22 | Processing liquid 1 | 3 | 5 | 20 | 400 | 0.65 | NaOH | 120,000 | C | A | A |
| example 4 | | | | | | | | | | | | |
| Comparative | Ink 23 | Processing liquid 1 | 3 | 4 | 15 | 100 | 0.1 | NaOH | 30,000 | B | C | A |
| example 5 | | | | | | | | | | | | |
| Comparative | Ink 24 | Processing liquid 1 | 3 | 6 | 110 | 100 | 0.1 | NaOH | 30,000 | C | B | A |
| example 6 | | | | | | | | | | | | |
| Comparative | Ink 25 | Processing liquid 1 | 15 | 7 | 110 | 100 | 0.1 | Tri- | 40,000 | C | A | A |
| example 7 | | | | | | | | ethanol- | | | | |
| | | | | | | | | amine | | | | |
| Comparative | Ink 26 | Processing liquid 1 | 15 | 3 | 15 | 400 | 0.1 | NaOH | 40,000 | A | B | A |
| example 8 | | | | | | | | | | | | |
| Comparative | Ink 27 | Processing liquid 1 | 15 | 5 | 20 | 80 | 0.1 | NaOH | 30,000 | C | A | A |
| example 9 | | | | | | | | | | | | |

The ejectability, the image density, and the drying property shown in Tables I and 2 are evaluated according to the methods and the criteria shown below.

Ejectability

The ejectability is evaluated by visually observing whether lines due to incorrect ejection direction or lack of ejection in the solid image are formed on the continuously printed papers. The evaluation criteria are as follows:

E: Line is observed before finishing printing of 500 sheets, but lack of ejection is not caused.

A: Line is observed before finishing printing of 100 sheets, but lack of ejection is not caused.

B: Line is observed before finishing printing of 100 sheets, but this phenomenon can be eliminated by maintenance operation.

C: Line is observed before finishing printing of 100 sheets, and this phenomenon cannot be eliminated by maintenance operation.

Image Density

The image density is evaluated by measuring the solid image obtained (excluding the low-density images described above) by using a densitometer (trade name: X-RITE® 404, manufactured by X-Rite). The evaluation criteria are as follows:

A: Image density: 1.2 or more

B: Image density: 1.1 or more and less than 1.2

C: Image density: less than 1.1

Drying Property

The drying property is evaluated by measuring the period of time from when immediately after printing of the solid image to when no transferring of ink in the solid image becomes observed onto a white paper when the white paper is placed on the solid image and pressed under a load of 100 g/cm². The evaluation criteria are as follows:

A: Period until no ink transfer is less than 1 second.

B: Period until no ink transfer is 1 second or more and less than 3 seconds.

C: Period until no ink transfer is 3 seconds or more.

What is claimed is:

1. An ink set comprising: an ink comprising a pigment and a resin that disperses the pigment; and a liquid that coagulates the pigment, wherein:
the neutralization degree of the resin is in a range of about 0.1 to 0.6;
the acid value of the resin is in a range of about 100 to 400 KOH mg/g; and
the amount of the resin contained in the ink is in a range of about 20 to 100% by mass relative to the amount of the pigment contained in the ink.

2. The ink set of claim 1, wherein the amount of a resultant residue in a supernatant liquid that can be obtained by centrifuging the ink is equal to or less than 4% by mass relative to the total mass of the ink.

3. The ink set of claim 1, wherein the molecular weight of the resin is in a range of about 8,000 to 10,000.

4. The ink set of claim 1, wherein the amount of the pigment contained in the ink is in a range of about 3 to 15% by mass relative to the total mass of the ink.

5. The ink set of claim 1, wherein the ink comprises four or more colors of inks, at least one of which is a black ink.

6. An ink jet recording method comprising forming an image by imparting an ink set onto a surface of a recording medium, wherein:
the ink set comprises: an ink comprising a pigment and a resin that disperses the pigment; and a liquid that coagulates the pigment;
the ink and the liquid are imparted so as to contact with each other on the surface of the recording medium;
the neutralization degree of the resin is in a range of about 0.1 to 0.6;
the acid value of the resin is in a range of about 100 to 400 KOH mg/g; and
the amount of the resin contained in the ink is in a range of about 20 to 100% by mass relative to the amount of the pigment contained in the ink.

7. The ink jet recording method of claim 6, wherein the amount of a resultant residue in a supernatant liquid that can be obtained by centrifuging the ink is equal to or less than 4% by mass relative to the total mass of the ink.

8. The ink jet recording method of claim 6, wherein the molecular weight of the resin is in a range of about 8,000 to 10,000.

9. The ink jet recording method of claim 6, wherein the amount of the pigment contained in the ink is in a range of about 3 to 15% by mass relative to the total mass of the ink.

10. The ink jet recording method of claim 6, wherein the ink comprises four or more colors of inks, at least one of which is a black ink.

11. A droplet ejecting apparatus comprising a droplet ejecting unit that forms an image by ejecting droplets of an ink set onto a surface of a recording medium, wherein:
the ink set comprises: an ink comprising a pigment and a resin that disperses the pigment; and a liquid that coagulates the pigment;
the ink and the liquid are ejected so as to contact with each other on the surface of the recording medium;
the neutralization degree of the resin is in a range of about 0.1 to 0.6;
the acid value of the resin is in a range of about 100 to 400 KOH mg/g; and
the amount of the resin contained in the ink is in a range of about 20 to 100% by mass relative to the amount of the pigment contained in the ink.

12. The droplet ejecting apparatus of claim 11, wherein the droplet ejecting unit ejects the droplets by applying pressure to the droplets.

13. The droplet ejecting apparatus of claim 11, wherein the droplet ejecting unit ejects the droplets by applying heat to the droplets.

14. The droplet ejecting apparatus of claim 11, wherein the amount of a resultant residue in a supernatant liquid that can be obtained by centrifuging the ink is equal to or less than 4% by mass relative to the total mass of the ink.

15. The droplet ejecting apparatus of claim 11, wherein the molecular weight of the resin is in a range of about 8,000 to 10,000.

16. The droplet ejecting apparatus of claim 11, wherein the amount of the pigment contained in the ink is in a range of about 3 to 15% by mass relative to the total mass of the ink.

17. The droplet ejecting apparatus of claim 11, wherein the ink comprises four or more colors of inks, at least one of which is a black ink.
